(19) United States
(12) Patent Application Publication
(10) Pub. No.: US 2026/0032560 A1
(43) Pub. Date: Jan. 29, 2026

(54) METHODS AND APPARATUS FOR MANAGING RADIO ACCESS TECHNOLOGIES RESTRICTIONS IN WIRELESS NETWORKS

(71) Applicant: Samsung Electronics Co., Ltd., Gyeonggi-do (KR)

(72) Inventors: Danish Ehsan HASHMI, Bengaluru (IN); Anurag MANDILWAR, Bengaluru (IN); Arvind RAMAMURTHY, Bengaluru (IN); Jagadeesh GANDIKOTA, Bengaluru (IN); Lalith KUMAR, Bengaluru (IN); Pratibha Kattemane SATYAGANAPATI, Bengaluru (IN)

(21) Appl. No.: 19/279,462

(22) Filed: Jul. 24, 2025

(30) Foreign Application Priority Data
Jul. 24, 2024 (IN) 202441056455
Jul. 8, 2025 (IN) 2024 41056455

(51) Int. Cl. H04W 48/02; H04W 48/20; H04W 84/04

(52) U.S. Cl. CPC H04W 48/02; H04W 48/20; H04W 84/042

(57) ABSTRACT

The present disclosure relates to a 5G or 6G communication system for supporting higher data transmission rates and satisfying various service requirements. A method performed by a terminal in a communication system is provided. The method includes transmitting, to a network function managing mobility, a first NAS message including capability information, wherein the capability information indicates whether the terminal supports an access technology utilization control; receiving, from the network function, a second NAS message including information on the access technology utilization control, wherein the information on the access technology utilization control indicates restricted access technology associated with a current PLMN; storing the information on the access technology utilization control; and applying the information on the access technology utilization control for a cell selection and a cell reselection in the current PLMN for restricting an access to the restricted access technology.

### CROSS-REFERENCE TO RELATED APPLICATION(S)

This application is based on and claims priority under 35 U.S.C. § 119 to Indian Provisional Patent Application No. 202441056455, filed on Jul. 24, 2024, in the Indian Patent Office, and Indian Non-Provisional patent application No. 202441056455, filed on Jul. 8, 2025, in the Indian Patent Office, the disclosures of which are incorporated herein by reference in their entireties.

### BACKGROUND

### 1. Field

The disclosure relates generally to operation of a terminal and a network entity (NE) in wireless communication networks, and more particularly, to managing radio access technologies (RAT) restrictions for enhancement of controlling RAT utilization (ECRATU) in wireless communication networks.

### 2. Description of Related Art

5^{th} generation (5G) mobile communication technology defines a wide frequency band to enable fast transmission speeds and new services, and can be implemented not only in the sub-6 gigahertz (GHz) frequency band such as 3.5 GHz, but also in the ultra-high frequency band referred to as millimeter wave (mm Wave) bands such as 28 GHz and 39 GHz (above 6 GHz) bands. In 6^{th} generation (6G) mobile communication technology, referred to as beyond 5G, it is expected that it will be paramount to secure new frequency resources such as the sub-6 GHZ band, ultra-high frequency bands, and upper mid band (7-24 GHz) to handle the rapidly increased data traffic due to the spread of artificial intelligence (AI) technology and the increase in streaming services, to improve user perceived performance, and to efficiently utilize all available frequency resources as needed. To this end, reallocation, reuse, or sharing of existing frequency bands from 2^{nd} generation (2G) to 5G for 6G can be considered.

Since the introduction of 5G, the communications market has been increasingly interested in improving system operation efficiency, sustainability, and user experience. Accordingly, in addition to improving traditional communications performance such as data transmission speed and delay time, the introduction of new innovative technologies such as AI, reducing operating costs, improving energy efficiency, expanding service coverage, and introducing new services are becoming increasingly important.

Since the early stages of 5G mobile communication technology, a goal has been to support services and satisfy performance requirements for enhanced mobile broadband (eMBB), ultra-reliable low-latency communications (URLLC), and massive machine-type communications (mMTC), including beamforming and massive multiple-input multiple-output (MIMO) to mitigate path loss of radio waves in ultra-high frequency bands and increase the range of radio transmission, support for various numerologies (such as operation of multiple subcarrier intervals) and dynamic operation of slot formats for efficient use of ultra-high frequency resources, initial access technology to support multi-beam transmission and wideband, definition and operation of band-width part (BWP), new channel coding methods such as low density parity check (LDPC) codes for large-capacity data transmission and polar codes for reliable transmission of control information, layer 2 (L2) pre-processing, and networks that provide dedicated networks specialized for specific services. Standardization of slicing (network slicing) etc. has been progressing.

Furthermore, discussions have been held on improving and enhancing the initial 5G mobile communication technology in consideration of the services that 5G mobile communication technology was intended to support, including vehicle-to-everything (V2X) to help autonomous vehicles make decisions based on their own location and status information transmitted by the vehicle and to increase user convenience, new radio unlicensed (NR-U) for system operation that meets various regulatory requirements in unlicensed bands, NR terminal low power consumption technology (i.e., UE power saving), non-terrestrial network (NTN), which is direct terminal-satellite communication to secure coverage in areas where communication with terrestrial networks is impossible, positioning, NR support up to 71 GHZ, support of reduced capability NR devices for lower cost and complexity compared to general terminals, user equipment (UE) power saving enhancement for improved power management in preparation for the use of various terminal types, and sidelink. Standardization of the physical layer has been performed for technologies such as sidelink enhancement, duplex enhancements which study a new form of duplexing called subband non-overlapping full duplex (SBFD), network energy saving which secures the idle period in which the base station operates in maximum power saving mode to the maximum extent and reduces power consumption, and network controlled repeaters which have improved performance compared to existing repeaters by having the function of receiving and processing side control information from the network.

In addition, standardization of the wireless interface architecture/protocol layer for technologies such as the industrial Internet of things (IIoT) for supporting new services through linkage and convergence with other industries, integrated access and backhaul (IAB) that provides nodes for expanding network service areas by integrating wireless backhaul links and access links, mobility enhancement technology including conditional handover (CHO) and dual active protocol stack (DAPS) handover, 2-step random access channel (RACH) for NR that simplifies random access procedures, multicast and broadcast, standardization of support for multi universal subscriber identity module (USIM) devices that provide services to users using information of two or more subscriber identity modules (SIMs), sidelink relay that provides relay-related functions to support connections between terminals in long distances and between terminals and networks, small data transfer (SDT) which transmits small data or signaling in an inactive state without transitioning to a connected state, mobility enhancements including layer 1 (L1)/L2 triggered mobility (LTM)/subsequent conditional PSCell addition/change (SCPAC)/and conditional handover (CHO) with candidate SCGs, extended reality (XR) enhancement to support XR services in NR systems, etc. has also been performed, and standardization of system architecture/services such as 5G baseline architecture (e.g., service-based architecture, service-based interface) for grafting network functions virtualization (NFV) and software-defined networking (SDN) technologies, mobile edge computing (MEC) that provides services based on the location of the terminal, non-public networks (NPN) that can be used only by some permitted terminals for non-public purposes, disaster roaming that supports the use of communication services through other carriers' networks in the event of a communication disaster, proximity-based service via 5GS, and unmanned Standardization has also been made in the system architecture/service areas, including support of an unmanned aircraft system (UAS) to support remote identification, tracking, and authorization of uncrewed aerial vehicles (UAVs), structural enhancements to support XR and interactive media services, 5GS to support AI/machine learning (ML) services, and advanced mobile edge computing to provide edge computing services in roaming networks, etc. has also been performed.

Currently, standardization is in progress for technologies such as beam prediction using AI/ML technology, channel state information (CSI) prediction to improve positioning accuracy, ultra-low-power terminal technology using low-power wake-up receivers, technology for transmitting long term evolution (LTE) broadcasts to 5G networks, MIMO transmission technology using multiple base stations, and ultra-low-power terminals (ambient IoT) that transmit data by obtaining power from an external source without a battery. At the radio interface architecture/protocol layer, standardization is in progress for technologies such as LTM scenario support and conditional LTM support between central units (CUs), simultaneous support for the same XR service between multiple devices, NTN coverage enhancement and evolution, AI/ML-based mobility support, and terminal-to-terminal connection relay across multiple hops between terminals and networks.

In addition, standardization of system architecture/service fields for satellite communication optimization methods, 5G system energy usage management and efficiency, SBI-based user plane evolution, ambient IoT technology, data service provision methods in IMS (IP multimedia subsystem), and avatar communication service persists. When such 5G mobile communication systems are commercialized, a vast increase in devices connected to the communication network will be realized, and accordingly, it is expected that the functions and performance of 5G mobile communication systems will be strengthened and integrated operation of connected devices will be required. To this end, new research will be additionally conducted on XR to efficiently support augmented reality (AR), virtual reality (VR), and mixed reality (MR), 5G performance improvement and complexity reduction using AI/ML, AI service support, metaverse service support, and drone communication.

The development of these 5G mobile communication systems is expected to serve as the basis for enhancing 5G performance and ultimately evolving into 6G. In the 6G era, eMBB, URLLC, and mMTC services, are expected to evolve into immersive communication (IC), hyper-reliable and low-latency communication (HRLLC), and massive communication (MC) services, respectively. In addition, new services such as AI and communication, integrated sensing and communication, and ubiquitous connectivity are expected to be additionally supported. For these 6G services, improved performance requirements compared to 5G are also essential, and standardization to define these is also in progress.

In this manner, to satisfy the expanded services and improved performance requirements of 6G, it is expected that it will be essential to optimize and improve system operation, such as introducing AI technology, improving energy efficiency, expanding coverage, and applying next-generation security technology, as well as developing sustainable communication technology, in addition to simply improving existing communication performance.

To this end, the latest AI technology is applied to all areas from the communication system design stage to development, management, and operation to improve communication performance and realize AI internalization technology that realizes network automation and efficiency, technology that improves user-perceived performance and network operation efficiency by improving power consumption of networks and terminals, technology that reduces power consumption in core base station components such as radio frequency (RF) and modems and in the channel coding and signal modulation and transmission/reception processes, multi-antenna transmission technology (e.g., extreme MIMO (X-MIMO)) that utilizes large antennas to overcome propagation path loss due to high frequency compared to the 3.5 GHz band of 5G communication and provide equivalent coverage, transmission/reception technology based on multiple base stations (e.g., distributed MIMO (D-MIMO)) to improve quality in cell edge areas, full-duplex communication (e.g., SBFD) technology to improve frequency efficiency and system network, next-generation encryption technology (e.g., post quantum cryptography (PQC)) and zero trust architecture (ZTA) technology to strengthen 6G communication security, and initial access delay and mobility. Research will be focused on technologies to minimize delay, design a hardware-friendly protocol structure for ultra-high-speed data processing, and expand the application of integrity protection technologies.

In addition, research will be conducted on the structure of mobile communication systems (prevention of redundant functions, simplification of functions, etc.), introduction of new planes for providing service providers, user privacy protection measures, realistic services, enhancement of network resiliency, network sharing technologies, improved security technologies (false base stations, lower layer protection, etc.), and intent-based network operation and management.

In a national roaming environment, enabling the UE unrestricted use of all RATs (e.g., LTE and 5GS) can lead to interoperability issues, service-quality degradation, and increased network congestion.

Specifically, national roaming services play a crucial role in maintaining seamless connectivity, particularly in regions where a user's primary network operator does not provide coverage. However, enabling national roamers unrestricted access to various RATs can lead to technical challenges such as interoperability issues, degradation in quality of service, and increased risk of network congestion.

As per the requirements defined in CP-241298, and C4-24203 in the 3^{rd} generation partnership project (3GPP) technical specification (TS),
CT1:
a) Continue enhancements in evolved packet system (EPS) and fifth-generation system (5GS) related to the delivery of RAT utilization restriction information to the UE, along with defining the corresponding UE behavior.
b) Define criteria for re-enabling a previously disabled RAT.
CT2:
   a) Consider potential updates to access restriction data in a home location register (HLR) to support RAT utilization limitation at a serving GPRS support node (SGSN).
   b) Consider potential updates to access restriction data in a home subscriber server (HSS) to support RAT utilization limitation at a mobility management entity (MME).
   c) Consider potential updates to access restriction data in the unified data management/unified data repository (UDM/UDR) to support RAT utilization limitation at the access and mobility management function (AMF).

The current mechanism to limit the UEs utilization of certain RAT employed by the network operators involves rejecting the UE's attach/tracking area update (TAU) request or the registration request with CC #15 or #27 upon the UE attempts to attach/register via a specific RAT (i.e. if the NG-RAN is restricted or not allowed then network/AMF reject the UE registration attempts with 5G mobility management (MM) cause #27 and if the evolved universal terrestrial radio access network (E-UTRAN) is not allowed then network/MME reject the TAU request or attach request with EMM cause #15).

However, this existing mechanism results in higher signaling load within the network, prolonged service outages until the UE selects another RAT, and repeated attempts by the UE to use the same PLMN/RAT once that the corresponding RAT is re-enabled.

Accordingly, there is a need in the art for methods for effectively delivering RAT-restriction information to the UE and for defining the criteria under which a previously restricted RAT may be re-enabled.

### SUMMARY

The disclosure has been made to address the above-mentioned problems and disadvantages, and to provide at least the advantages described below.

An aspect of the disclosure is to provide methods and systems for managing RAT restrictions for ECRATU in wireless networks.

An aspect of the disclosure is to enable a UE to indicate a capability restriction information feature to an NE to facilitate RAT restriction management.

An aspect of the disclosure is to ensure a policy restricting access to one or more RATs is delivered to the UE based on the indicated capability restriction information.

An aspect of the disclosure is to support dynamic and policy-driven control of RAT accessibility in a wireless network environment.

An aspect of the disclosure is to improve network efficiency and compliance with device-specific capabilities for capability-based RAT restriction policies.

An aspect of the disclosure is to enable the UE to determine whether the UE is in at least one of an emergency situation, a manual network selection mode and a disaster area.

An aspect of the disclosure is to enable the UE to either applying the policy at the UE and replacing a current policy running in the UE in response to determining that the UE is not in at least one of: the emergency situation, the manual network selection mode and the disaster area or, discarding the policy at the UE and retaining a current policy running in the UE in response to determining that the UE is in at least one of: the emergency situation, the manual network selection mode and the disaster area.

An aspect of the disclosure is to enable the NE to receive an indication of a capability restriction information feature from a UE.

An aspect of the disclosure is to enable the NE to send a policy to restrict an access of a RAT to the UE based on the capability restriction information feature.

An aspect of the disclosure is to enable the network to restrict the UE's access to a specific RAT by configuring information on access-technology utilization control to the UE.

Since the UE refrains from attempting to access those restricted RATs, unnecessary signaling exchanges with the network are avoided, thereby reducing the UE's power consumption.

Additionally, by providing exceptional cases under which the UE is allowed to access to restricted RATs, the system can support a more flexible access technology utilization control framework.

In accordance with an aspect of the disclosure, a method performed by a terminal in a communication system is provided. The method includes transmitting, to a network function managing mobility, a first non-access stratum (NAS) message including capability information, wherein the capability information indicates whether the terminal supports an access technology utilization control, receiving, from the network function managing mobility, a second NAS message including information on the access technology utilization control, the information on the access technology utilization control indicating restricted access technology associated with a current public land mobile network (PLMN), storing the information on the access technology utilization control, and applying the information on the access technology utilization control for a cell selection and a cell reselection in the current PLMN for restricting an access to the restricted access technology.

In accordance with an aspect of the disclosure, a method performed by a network function managing mobility in a communication system is provided. The method includes receiving, from a terminal, a first NAS message including capability information, wherein the capability information indicates whether the terminal supports an access technology utilization control, and transmitting, to the terminal, a second NAS message including information on the access technology utilization control, the information on the access technology utilization control indicating restricted access technology associated with a current PLMN, wherein the information on the access technology utilization control is applied for a cell selection and a cell reselection in the current PLMN for restricting an access of the terminal to the restricted access technology

In accordance with an aspect of the disclosure, a terminal in a communication system is provided. The terminal includes a transceiver, a processor communicatively coupled to the transceiver, and memory, communicatively coupled to the processor, storing instructions executable by the processor to cause the terminal to transmit, to a network function managing mobility, a first NAS message including capability information, wherein the capability information indicates whether the terminal supports an access technology utilization control, receive, from the network function managing mobility, a second NAS message including information on the access technology utilization control, the information on the access technology utilization control indicating restricted access technology associated with a current PLMN, store the information on the access technology utilization control, and apply the information on the access technology utilization control for a cell selection and a cell reselection in the current PLMN for restricting an access to the restricted access technology.

In accordance with an aspect of the disclosure, a network function managing mobility in a communication system is provided. The network function includes a transceiver, a processor communicatively coupled to the transceiver, and memory, communicatively coupled to the processor, storing instructions executable by the processor to cause the network function to receive, from a terminal, a first NAS message including capability information, wherein the capability information indicates whether the terminal supports an access technology utilization control, and transmit, to the terminal, a second NAS message including information on the access technology utilization control, the information on the access technology utilization control indicating restricted access technology associated with a current PLMN, wherein the information on the access technology utilization control is applied for a cell selection and a cell reselection in the current PLMN for restricting an access of the terminal to the restricted access technology.

### BRIEF DESCRIPTION OF THE DRAWINGS

The above and other aspects, features, and advantages of certain embodiments of the disclosure will be more apparent from the following detailed description taken in conjunction with the accompanying drawings, in which:

FIG. 1 illustrates a sequence diagram of a scenario, wherein a UE receives RAT restriction information as a result of UE initiated procedure, according to an embodiment;

FIG. 2 illustrates various hardware components of the UE, according to an embodiment;

FIG. 3 illustrates various hardware components of an NE, according to an embodiment;

FIG. 4 illustrates a method wherein the UE receives RAT restriction information as a result of UE initiated procedure, according to an embodiment;

FIG. 5 is a method illustrating the network initiated procedure, wherein the network can deliver RAT restriction policy to the UE, according to an embodiment;

FIG. 6 illustrates a network initiated procedure, wherein the network can deliver RAT restriction policy to the UE, according to an embodiment;

FIG. 7 illustrates a method, wherein the policy related to RAT Restriction Information can be delivered to the UE by the PCF, according to an embodiment;

FIG. 8 illustrates a method for re-enabling a restricted RAT (lifting a RAT restriction) by policy update, according to an embodiment;

FIG. 9 illustrates a method wherein the RAT restriction is removed due to change of PLMN/tracking area identity (TAI)/Cell/Area, according to an embodiment;

FIG. 10 illustrates a method wherein the RAT restriction is removed due to a disaster roaming condition, according to an embodiment;

FIG. 11 illustrates a method, wherein the RAT restriction is removed due a due to timer expiry, according to an embodiment;

FIG. 12 illustrates a method, wherein the RAT restriction is removed due to manual or emergency mode, according to an embodiment; and

FIG. 13 illustrates the RAT restriction information/policy, according to an embodiment.

### DETAILED DESCRIPTION

Hereinafter, embodiments of the disclosure are described in detail with reference to the accompanying drawings. It should be noted that in the drawings, the same or similar elements are preferably denoted by the same or similar reference numerals. Detailed descriptions of known functions or configurations that may make the subject matter of the disclosure unclear will be omitted for the sake of clarity and conciseness.

Terms described below are terms defined in consideration of functions in the disclosure, which may vary according to intentions or customs of users and providers. Therefore, the definition should be made based on the content throughout this specification.

Some components are exaggerated, omitted, or schematically illustrated in the accompanying drawings. The size of each component does not fully reflect the actual size. In each drawing, the same reference numerals are given to the same or corresponding components.

Herein, an element is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

For the purposes of interpreting this specification, the definitions (as defined herein) will apply and whenever appropriate the terms used in singular will also include the plural and vice versa. It is to be understood that the terminology used herein is for describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration. Any embodiment or implementation of the present subject matter described herein using these words/phrases is not necessarily to be construed as preferred or advantageous over other embodiments.

Elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. In terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. In terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

Usage of words such as first, second, third etc., to describe components/elements/steps is for the purposes of this description and should not be construed as sequential ordering/placement/occurrence unless specified otherwise.

Once a RAT restriction policy is provisioned to the UE, and the UE applies RAT restriction, re-enabling of the restricted RAT will be enabled.

As per Reject cause #15 (No suitable cells in tracking area), the UE shall set the 5GS update status to 5U3 ROAMING NOT ALLOWED (and shall store it according to subclause 5.1.3.2.2) and shall delete any last visited registered TAI and TAI list. If the UE is not registering or has not registered to the same PLMN over both 3GPP access and non-3GPP access, the UE shall additionally delete 5G globally unique temporary identity (5G-GUTI) and next generation key set identifier (ngKSI).

Additionally, the UE shall reset the registration attempt counter. If:
1) the UE is not operating in a standalone NPN (SNPN) access operation mode and the forbidden TAI(s) for the list of “5GS forbidden tracking areas for roaming” information element (IE) is not included in the REGISTRATION REJECT message, the UE shall store the current TAI in the list of “5GS forbidden tracking areas for roaming” and enter the state 5GMM-DEREGISTERED.LIMITED-SERVICE. If the REGISTRATION REJECT message is not integrity protected, the UE shall memorize the current TAI was stored in the list of “5GS forbidden tracking areas for roaming” for non-integrity protected NAS reject message; or
2) the UE is operating in the SNPN access operation mode, the UE shall store the current TAI in the list of “5GS forbidden tracking areas for roaming” for the current SNPN and the selected entry of the “list of subscriber data” or the selected PLMN subscription and enter the state 5GMM-DEREGISTERED.LIMITEDSERVICE.

If the REGISTRATION REJECT message is not integrity protected, the UE shall memorize the current TAI was stored in the list of “5GS forbidden tracking areas for roaming” for the current SNPN and the selected entry of the “list of subscriber data”
or the selected PLMN subscription, for non-integrity protected NAS reject message.

The UE shall search for a suitable cell in another tracking area according to the relevant standard (e.g., 3GPP TS 38.304 or 3GPP TS 36.304).

As per Reject cause #27, (N1 mode not allowed), the UE shall set the 5GS update status to 5U3 ROAMING NOT ALLOWED and shall store it according to the relevant standard (e.g., subclause 5.1.3.2.2) and shall delete any 5G-GUTI, last visited registered TAI, TAI list and ngKSI.

Additionally, the UE shall reset the registration attempt counter and shall enter the state 5GMM-DEREGISTERED.LIMITEDSERVICE. If the message has been successfully integrity-checked by the NAS, the UE shall set:
1) the PLMN-specific N1 mode attempt counter for 3GPP access and the PLMN-specific N1 mode attempt counter for non-3GPP access for the PLMN in case of PLMN; or
2) the SNPN-specific attempt counter for 3GPP access for the current SNPN in case of SNPN and the SNPN-specific attempt counter for non-3GPP access for the current SNPN; to the UE implementation-specific maximum value.

The UE shall disable the N1 mode capability for the specific access type for which the message was received (see subclause 4.9).

If the message has been successfully integrity checked by the NAS, the UE shall disable the N1 mode capability also for the other access type (see subclause 4.9).

The terms Rat-Type, RAT or AT are used interchangeably and have the same meaning and they represent at least one of the below: 5G, 4G, 3G, 2G, EPS, 5GS, NR, NR in unlicensed bands, NR low earth orbit (LEO) satellite access, NR medium earth orbit (MEO) satellite access, NR (GEO, geostationary orbit) satellite access, NR (OTHERSAT) satellite access, NR RedCap, E-UTRA, E-UTRA in unlicensed bands, NB-IoT or NB-S1, WB-IoT, LTE-M, and so on.

Herein, a method discloses managing RAT restriction in a wireless network includes the UE indicating a capability restriction information feature to an NE, and based on this, receiving a policy from the network to restrict access to a specific RAT. The method enables capability-driven RAT access control aligned with UE capabilities, improving network efficiency, reducing unnecessary signaling, minimizing RAT switching, and enhancing system performance along with user experience.

The UE indicates the capability (support of not support) of RAT restriction information feature to at least one of an AMF entity, an UDM entity or a PCF entity for e.g. using UPSI, MM capability information in any of the NAS or AS message. If the UE indicates support of the feature only then the UDM entity/PCF entity/AMF entity indicates the RAT restriction information to the UE.

If the UE indicates support of the access technology utilization control in the REGISTRATION REQUEST message over 3GPP access and the network decides to apply the access technology utilization control, the AMF shall include the Access technology utilization control IE in the REGISTRATION ACCEPT message.

The AMF may send the integrity protected REGISTRATION REJECT message with the 5GMM cause value set to #15 “No suitable cells in tracking area” and include the access technology utilization control IE with the type of access technology utilization control set to “current PLMN”. In the access technology utilization control IE, the AMF shall indicate that the access technology of the NG-RAN cell on which the REGISTRATION REQUEST message was received is restricted.

The UE indicated support of the access technology utilization control, the network determines to apply the access technology utilization control based on the operator policy and the secure exchange of NAS messages via an N1 NAS signaling connection is established between the UE and the AMF then the AMF shall send the integrity protected SERVICE REJECT message with the 5GMM cause value set to #15 “No suitable cells in tracking area” and include the access technology utilization control IE. In the Access technology utilization control IE, the AMF shall indicate that the access technology of the NG-RAN cell on which the SERVICE REQUEST message was received is restricted.

If the UE supporting access technology utilization control receives the access technology utilization control IE with the length of access technology utilization control contents field set to a non-zero value, in the CONFIGURATION UPDATE COMMAND message, the UE shall store the received access technology utilization control information together with the PLMN identity of the current PLMN in the list of “PLMNs with associated access technology restrictions”.

If the UE supports access technology utilization control, the UE shall set the access technology utilization control (ATUC) bit to “access technology utilization control supported” in the 5GMM capability IE of the REGISTRATION REQUEST message.

The UE indicates whether the UE supports/does not support RAT restriction feature in the 5GMM capability IE of the registration request message to the AMF. The AMF further indicates whether the UE supports/does not support the RAT restriction feature received in the 5GMM capability IE to the PCF and UDM/HSS.

The UE indicates whether the UE supports/does not support RAT restriction feature in the MS network capability or UE network capability IE in the attach request or TAU request message to the MME. The MME further indicates whether the UE supports/does not support the RAT restriction feature received in the respective IE to the PCF and the UDM/HSS.

If the UE supports access technology utilization control, the UE shall set the ATUC bit to “access technology utilization control supported” in the UE network capability IE of the ATTACH REQUEST message.

If the UE indicates support of the access technology utilization control in the ATTACH REQUEST message and the network decides to apply the access technology utilization control, the MME shall include the access technology utilization control IE in the ATTACH ACCEPT message.

If the UE indicates support of the access technology utilization control in the TRACKING AREA UPDATE REQUEST message and the network decides to apply the access technology utilization control, the MME shall include the access technology utilization control IE in the TRACKING AREA UPDATE ACCEPT message.

If the UE indicates support of the access technology utilization control in the TRACKING AREA UPDATE REQUEST message, the network determines to apply the access technology utilization control based on the operator policy. The secure exchange of NAS messages via a NAS signaling connection is established between the UE and the MME then the MME shall send the integrity protected TRACKING AREA UPDATE REJECT message with the EMM cause value set to #15 “No suitable cells in tracking area” and include the access technology utilization control IE with the type of access technology utilization control set to “current PLMN”. In the access technology utilization control IE, the MME shall indicate that the access technology of the E-UTRAN cell on which the TRACKING AREA UPDATE REQUEST message was received is restricted.

If the UE indicated support of the access technology utilization control, the network determines to apply the access technology utilization control based on the operator policy and the secure exchange of NAS messages via a NAS signaling connection is established between the UE and the MME then the MME shall send the integrity protected SERVICE REJECT message with the EMM cause value set to #15 “No suitable cells in tracking area” and include the Access technology utilization control IE. In the access technology utilization control IE, the MME shall indicate that the access technology of the E-UTRAN cell on which the SERVICE REQUEST message was received is restricted.

Herein, RAT restriction information feature and access technology utilization control feature is interchangeably used.

The procedure can be initiated by the UE, wherein the UE can receive RAT restriction information as a result of a UE initiated procedure. In either of the UE triggered Requests to Network (i.e. Registration Request/Attach Request/Tracking Arca Request/Service Request/Deregistration request/Detach Request), the UE may request a RAT Restriction Information from the Network. In response, the Network shall provide RAT restriction information in at least one of the NAS message (such as, but not limited to, Registration Accept, Registration Reject, Attach accept, Attach reject, Tracking Area Update Accept, Tracking Area Update Reject, Service Accept, Service Reject, UE configuration update command (UCU) etc.).

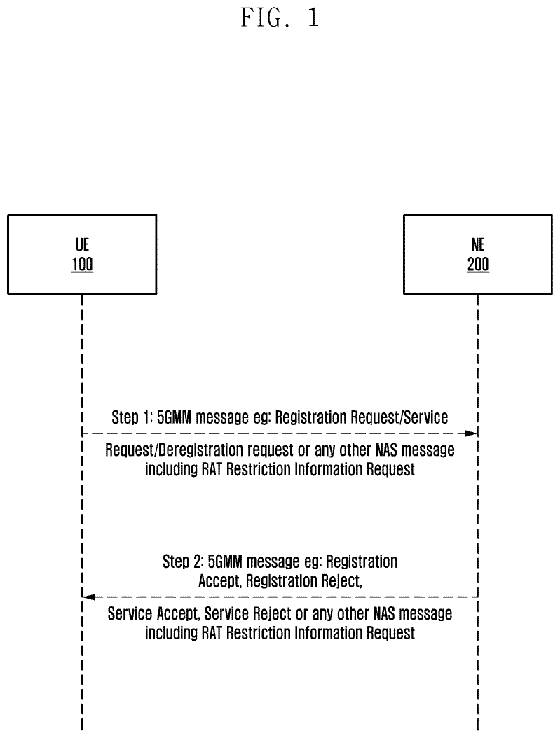

FIG. 1 illustrates a sequence diagram of a scenario, wherein a UE receives RAT restriction information as a result of a UE initiated procedure, according to an embodiment.

Referring to FIG. 1, in a 5G MM NAS signaling message, in step 1, the UE (100) sends a Registration Request/Service Request/Deregistration request to an NE (200) (wherein the NE can be AMF (300)) including request for RAT restriction information from the NE. The UE (100) initiates a NAS procedure with optionally the RAT restriction request. In a 5GMM NAS signaling procedure, the UE (100) initiates a Registration Request, Service Request, or Deregistration Request message to the NE (100).

As part of the message, the UE (100) indicates support for the capability restriction information feature (if supported) and may also optionally request the RAT Restriction Information from the network. The presence of indication serves as a trigger for the network to determine whether RAT restriction information should be communicated to the UE (100).

In step 2, the network, i.e. visiting PMLN/home PLMN (VPLMN/HPLMN) indicates RAT Restriction Information to the UE (100) in Registration Accept, Registration Reject, Service Accept, Service Reject, or any other NAS message sent to the UE 100. Upon receiving the UE's request and confirming support for the capability, the NE (for example, VPLMN or HPLMN) evaluates and determines the applicable RAT Restriction Policy. Moreover, the NE (200) includes the RAT Restriction Information in a corresponding downlink NAS message sent to the UE, including Registration Accept/Registration Reject, Service Accept/Service Reject, or Any other NAS message deemed appropriate for policy delivery. Moreover, the policy instructs the UE (100) for Radio Access Technologies (RATs) to be restricted (for example, not selected or reselected), and upon receipt, the UE (100) replaces any existing policy with the newly received one for the PLMN.

The UE (100) shall replace the previously stored entry associated with the current PLMN, if any, with the newly received access technology utilization control information together with the PLMN identity of the current PLMN in the list of “PLMNs with associated access technology restrictions”.

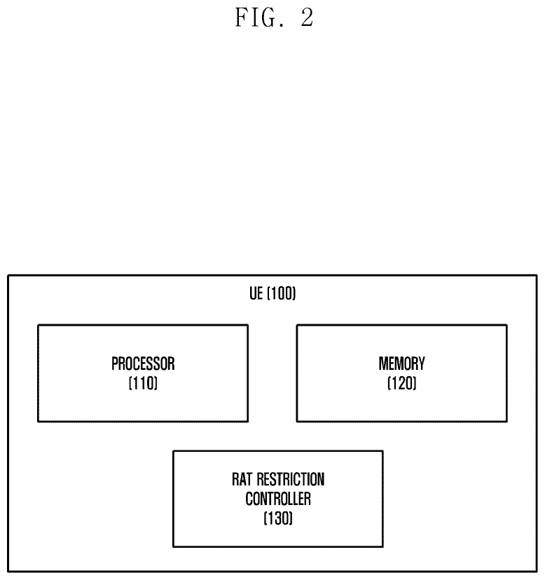

FIG. 2 illustrates various hardware components of the UE (100), according to an embodiment. Referring to FIG. 2, the UE (100) includes a processor (110), a memory (120), and a RAT restriction controller (130). The RAT restriction controller (130) is coupled with the processor (110) and the memory (130).

The RAT restriction controller (130) indicates a capability access technology utilization control supported restriction information feature to the NE (200). Based on the access technology utilization control supported indication, the RAT restriction controller (130) receives a policy in the access technology utilization control IE (information elements) policy indicating restricted or not restricted access of a RAT in technology in the wireless network (1000).

The RAT restriction controller (130) is configured to send the updated policy to restrict the access of the RAT to the UE (100). The RAT restriction controller (130) determines whether the UE (100) is in at least one of an emergency situation (e.g. registered for emergency services or having emergency bearer or initiated emergency call), a manual network selection mode and in a disaster roaming area. The RAT restriction controller (130) applies the policy at the UE (100) in response to determining that the UE (100) is not in at least one of: the emergency situation, the manual network selection mode and the disaster roaming area (i.e., the MS is allowed to access a restricted PLMN/access technology combination included in the list of “PLMNs with associated access technology restrictions” to attach for emergency bearer services or to register for emergency services). The RAT restriction controller (130) may discard the policy at the UE (100) and ignoring the current policy running in the UE (100) in response to determining that the UE (100) is in at least one of: the UE (100) enters emergency mode, enter the manual network selection mode and the UE (100) enters disaster service area.

Alternatively, the UE (100) ignores the discarding policy means, the UE (100) store the received policy but is inapplicable (for an example, when the UE (100) enters the manual network selection mode, the UE (100) shall ignore the policy and search all RATs which the UE (100) supports for the available PLMN and indicates the results to the UE. Upon the UE (100) selecting a PLMN, the UE (100) shall ignore the policy for the registration).

The RAT restriction controller (130) applies the policy at the UE (100) and replaces a current policy running in the UE (100) to determining that the UE (100) is not in at least one of the emergency situation, the manual network selection mode and the disaster area. The RAT restriction controller (130) receives the updated policy from the NE. The RAT restriction controller (130) determines whether the UE (100) is in at least one of the emergency situation and the disaster roaming area. The RAT restriction controller (130) applies the updated policy at the UE (100) in response to determining that the UE (100) is not in at least one of the emergency situation and the disaster roaming area. Alternatively, the RAT restriction controller (130) discards the updated policy at the UE (100) and retains the policy in the UE (100) in response to determining that the UE (100) is in at least one of the emergency situation and the disaster area.

The RAT restriction controller (130) determines whether the UE (100) is in the emergency situation, the manual network selection mode and the disaster area. Alternatively, the RAT restriction controller (130) disables the current policy running in the UE (100) upon determining that the UE (100) is in at least one of the emergency situation, the manual network selection mode and the disaster area. Alternatively, the RAT restriction controller (130) enables the current policy running in the UE (100) upon determining that the UE (100) come out of at least one of the emergency situation (e.g. emergency call is ended, UE (100) is no longer registered for the emergency services or there is emergency bearer), the manual network selection mode (i.e. move to automatic network selection mode) and the disaster roaming area.

The UE (100) may not deactivate restricted access technology and may not select or reselect to the restricted access technology in the current policy running in the UE (100).

The policy comprises AT restriction information, wherein the RAT restriction information is provided based on at least one of a Per PLMN-ID and a Per access technology. The RAT is restricted on a per public land mobile network (PLMN) basis for the per PLMN-ID and wherein the Per RAT type indicates an information on whether the access technology is restricted or access technology is not restricted for the UE. The AT comprises at least one of an evolved universal terrestrial radio access network (E-UTRAN), a next generation RAN (NG-RAN), a satellite NG-RAN, satellite EUTRAN, GERAN, UTRAN, a sixth generation network and an LTE network.

The UE (100) receives the policy from the NE through a NAS message including at least one of a registration accept message, a registration reject message, an attach accept message, an attach reject message, a UE configuration command message, a TAU accept message, a TAU reject message, a detach request, a service accept message, and a service reject message.

The capability information access technology utilization control supported feature is indicated to the NE using a 5GMM capability information message, a 5GMM capability IE, a UE network capability IE wherein the 5GMM capability information message comprises at least one of a registration request message, UE network capability IE is sent using at least one of an attach request message, and a TAU request message.

Policy (or RAT restriction information) is sent in the Access technology utilization control IEI shown below in Table 1 and Table 2.

TABLE 1

| Access technology utilization control IEI | | | | | | | | octet 1 |
|---|---|---|---|---|---|---|---|---|
| Length of Access technology utilization control contents | | | | | | | | octet 2 |
| 0 | 0 | 0 | 0 | 0 | 0 | Type of access | | octet 3* |
| spare | spare | Spare | spare | spare | spare | technology utilization | | |
| | | | | | | control | | |
| 0 | 0 | Sat- | Sat-E- | NG- | E- | UTRAN | GERAN | octet 4* |
| spare | spare | NG- | UTRAN | RAN | UTRAN | | | |
| | | RAN | | | | | | |
| 0 | 0 | 0 | 0 | 0 | 0 | 0 | 0 | octet 5* |
| spare | spare | Spare | spare | spare | spare | spare | spare | |

TABLE 2
Type of access technology utilization control (octet 3, bit 1 to 2)

| Bits | |
|---|---|
| 2 1 | |
| 0 0 | current PLMN |
| 0 1 | current PLMN and its equivalent PLMN(s) |
| 1 0 | Unused, shall be interpreted as “current PLMN” |
| | if received by the UE |
| 1 1 | Unused, shall be interpreted as “current PLMN” |
| | if received by the UE |

If Type of RAT utilization control = “00”, octet 4 applies to the current
PLMN. If Type of RAT utilization control = “01”, octet 4 applies to the
current PLMN and PLMN(s) included the equivalent PLMNs list, if any.
RAT restriction information:
GERAN (octet 4, bit 1)

| Bit | |
|---|---|
| 1 | |
| 0 | GERAN is not restricted |
| 1 | GERAN is restricted |

UTRAN (octet 4, bit 2)

| Bit | |
|---|---|
| 2 | |
| 0 | UTRAN is not restricted |
| 1 | UTRAN is restricted |

E-UTRAN (octet 4, bit 3)

| Bit | |
|---|---|
| 3 | |
| 0 | E-UTRAN is not restricted |
| 1 | E-UTRAN is restricted |

NG-RAN (octet 4, bit 4)

| Bit | |
|---|---|
| 4 | |
| 0 | NG-RAN is not restricted |
| 1 | NG-RAN is restricted |

Sat-E-UTRAN (octet 4, bit 5)

| Bit | |
|---|---|
| 5 | |
| 0 | satellite E-UTRAN is not restricted |
| 1 | satellite E-UTRAN is restricted |

Sat-NG-RAN(octet 4, bit 6)

| Bit | |
|---|---|
| 6 | |
| 0 | satellite NG-RAN is not restricted |
| 1 | satellite NG-RAN is restricted |

All other bits in octet 4 and 5 are spare and shall be coded as zero,
if the respective octet is included in the information element.

In FIG. 2, the RAT restriction controller (130) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (110) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (110) may include multiple cores and is configured to execute the instructions stored in the memory (130).

The processor (110) is configured to execute instructions stored in the memory (120) and to perform various processes. A communicator is configured for communicating internally between internal hardware components and with external devices via one or more networks. The memory (120) also stores instructions to be executed by the processor (110). The memory (120) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (120) may, in some examples, be considered a non-transitory storage medium. The term “non-transitory” may indicate that the storage medium is not embodied in a carrier wave or a propagated signal. However, the term “non-transitory” should not be interpreted that the memory (120) is non-movable. In certain examples, a non-transitory storage medium may store data that can, over time, change (e.g., in random access memory (RAM) or cache).

Although FIG. 2 shows various hardware components of the UE (100), the UE (100) may alternatively include fewer or more components. The labels or names of the components are used only for illustrative purposes and does not limit the scope of the invention. One or more components can be combined to perform the same or substantially similar function in the UE (100).

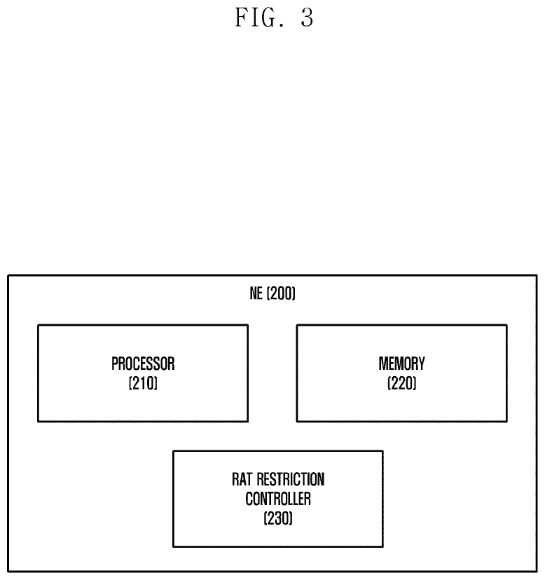

FIG. 3 illustrates various hardware components of the NE (200), according to an embodiment. Referring to FIG. 3, the NE (200) comprises a processor (210), a memory (220), and a RAT restriction controller (230), coupled with the processor and the memory.

The NE (200) can be, for example, but not limited to UDM (400), policy control function entity (PCF) (700), AMF (300), MME (600), and NF (800).

The RAT restriction controller (230) is configured to receive an indication of a capability access technology utilization control supported restriction information feature from the UE (100). The RAT restriction controller (230) is configured to send the policy in the Access technology utilization control IE (information elements) policy indicating restricted or not restricted access of a RAT in technology in the wireless network (1000) based on the access technology utilization control supported indication.

The RAT restriction controller (230) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (210) may include one or a plurality of processors. The one or the plurality of processors may be a general-purpose processor, such as a CPU, an AP, or the like, a graphics-only processing unit such as a GPU, a VPU, and/or an AI-dedicated processor such as an NPU. The processor (210) may include multiple cores and is configured to execute the instructions stored in the memory (220).

The processor (210) is configured to execute instructions stored in the memory (220) and to perform various processes. The communicator (not shown) is configured for communicating internally between internal hardware components and with external devices via one or more networks. The memory (220) also stores instructions to be executed by the processor (210). The memory (220) may include non-volatile storage elements. Examples of such non-volatile storage elements may include magnetic hard discs, optical discs, floppy discs, flash memories, or forms of EPROM or EEPROM memories. In addition, the memory (220) may, in some examples, be considered a non-transitory storage medium. The term “non-transitory” may indicate that the storage medium is not embodied in a carrier wave or a propagated signal. However, the term “non-transitory” should not be interpreted that the memory (220) is non-movable. In certain examples, a non-transitory storage medium may store data that can, over time, change (e.g., in a RAM or cache).

Although FIG. 3 shows various hardware components of the NE (300) but it is to be understood that other embodiments are not limited thereon. In other embodiments, the NE (300) may include fewer or more components. The labels or names of the components are used only for illustrative purposes and does not limit the scope of the invention. One or more components can be combined to perform the same or substantially similar function in the NE (300).

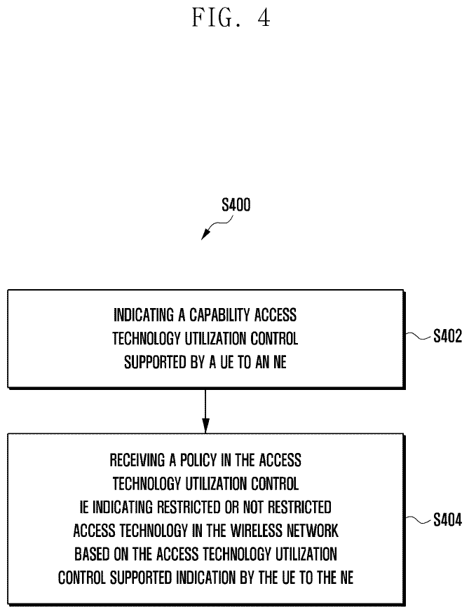

FIG. 4 illustrates a method S400 wherein the UE receives RAT restriction information as a result of UE initiated procedure, according to an embodiment.

Referring to FIG. 4, in step S402, the UE indicates a capability access technology utilization control supported to an NE, In step S404, the UE receives a policy in the Access technology utilization control IE (information elements) indicating restricted or not restricted access technology in the wireless network based on the access technology utilization control supported indication.

In a network initiated procedure, the network can deliver RAT restriction policy to the UE. The Network can store the RAT restriction policy in UDM/HSS/PCF in HPLMN/VPLMN given to the UE via the AMF using a steering of roaming (SOR) mechanism, UE parameter update (UPU) or UE policy delivery etc.:
a) SOR/UPU [from the UDM]. UE policy delivery [From PCF].
b) UCU procedure.

The UE can be updated about RAT Restriction Information using the UPU Procedure. The network can update the UE about RAT restriction information using control plane solution. The UDM has information about UE's RAT restriction. The network can deliver protected UDM update data via NAS signaling and update the UE regarding the same. In the UPU Container, the UDM can include new UE parameters update data set type ‘RAT Restriction Information’ to indicate RAT restriction information to the UE.

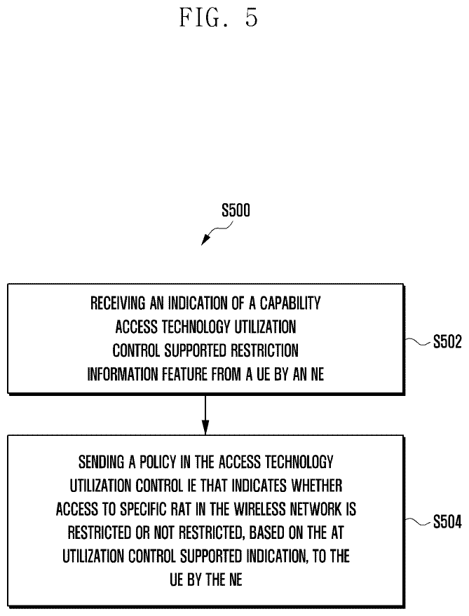

FIG. 5 is a method illustrating the network initiated procedure, wherein the network can deliver RAT restriction policy to the UE, according to an embodiment.

Referring to FIG. 5, the method (S500) is initiated by the NE. In step S502, the method includes receiving an indication of the capability access technology utilization control supported restriction information feature from the UE. In step S504, the method includes sending a policy in the access technology utilization control IE that indicates whether access to specific RAT in the wireless network is restricted or not restricted, based on the access technology utilization control supported indication, to the UE by the NE.

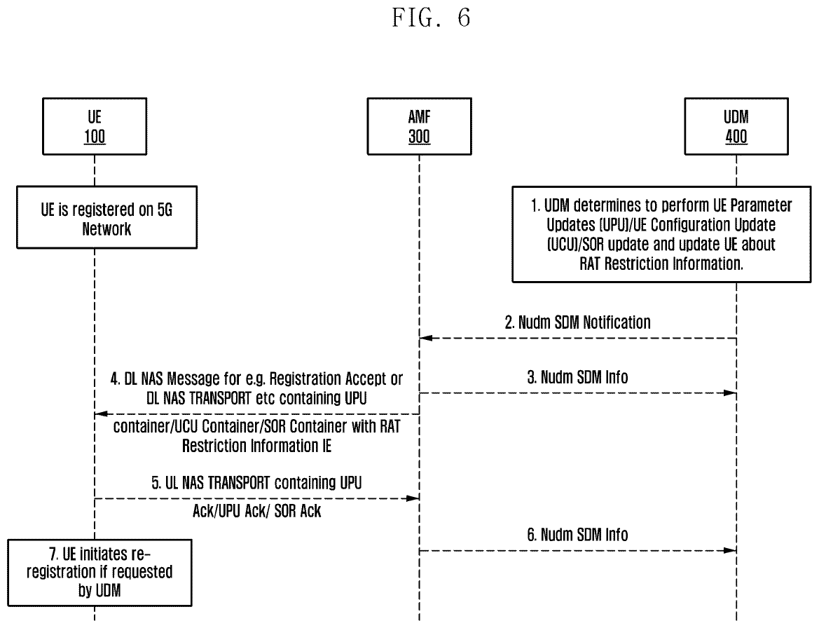

FIG. 6 illustrates a network initiated procedure, wherein the network can deliver RAT restriction policy to the UE, according to an embodiment.

Referring to FIG. 6, in a network including the AMF (300) and UDM (400), the UDM (400) initiates a UE (100) Parameter or Configuration Update to deliver RAT Restriction Information. The UDM (400) notifies the AMF (300) using the Nudm_SDM_Notification service, either during registration or via other service operations. If the UE (100) is unreachable, the AMF (300) informs the UDM (400), marking the update as pending. Once reachable, the AMF (300) sends a DL NAS message with the RAT restriction info. The UE (100) verifies the source and, if required, sends an acknowledgment via UL NAS TRANSPORT, which the AMF (300) forwards to the UDM (400). If re-registration is requested, the UE (100) proceeds after entering RRC_IDLE.

Specifically, in step 1, the UDM (400) determines to perform UE (100) parameter update (UPU)/UE configuration update (UCU)/SOR update to update the UE (100) on the RAT Restriction Information.

In step 2, the UDM (400) notifies the changes of the RAT Restriction Information related to the UE (100) to the affected AMF (300) by invoking a Nudm_SDM_Notification service operation. The Nudm_SDM_Notification service operation contains the UDM Update Data that needs to be delivered transparently to the UE (100) over NAS within the Access and Mobility Subscription data or the UDM (400) delivers the RAT Restriction Information to the AMF (300) during the registration procedure. Or it can be delivered from UDM (400)/UDR or any other NF in the network to the AMF (300) using at least one service operation.

In step 3, if the AMF (300) determines the UE (100) is unreachable, the AMF (300) invokes the Nudm_SDM_Info service operation to UDM (400) indicating that the transmission of UE (100) Parameters Update data is unsuccessful. The UDM (400) considers the procedure as UE (100) Parameters Update procedure as pending and subsequent steps 4-7 are skipped.

In step 4, the AMF (300) sends DL NAS Message for e.g., Registration Accept or DL NAS TRANSPORT etc. containing UPU container/UCU Container/SOR Container with RAT Restriction Information IE, message to the served UE. The AMF (300) includes in the DL NAS message the transparent container received from the UDM (400).

In step 5, if the UE (100) verifies that the UDM update data is provided by HPLMN, SNPN, or CH and the UDM (400) has requested the UE (100) to send an acknowledge to the UDM (400), the UE (100) sends an UL NAS TRANSPORT message to the serving AMF (300) with a transparent container including the UE (100) acknowledgement.

In step 6, if the AMF (300) receives an UL NAS TRANSPORT message with a transparent container carrying a UE acknowledgement from the UE (100), the AMF (300) sends a Nudm_SDM_Info request message including the transparent container to the UDM (400).

In step 7, if the UDM (400) requests the UE (100) to re-register, the UE (100) waits until the UE returns to RRC_IDLE and initiates a Registration procedure as defined in the relevant standard.

The policy related to RAT Restriction Information can be delivered to the UE (100) by the PCF (700).

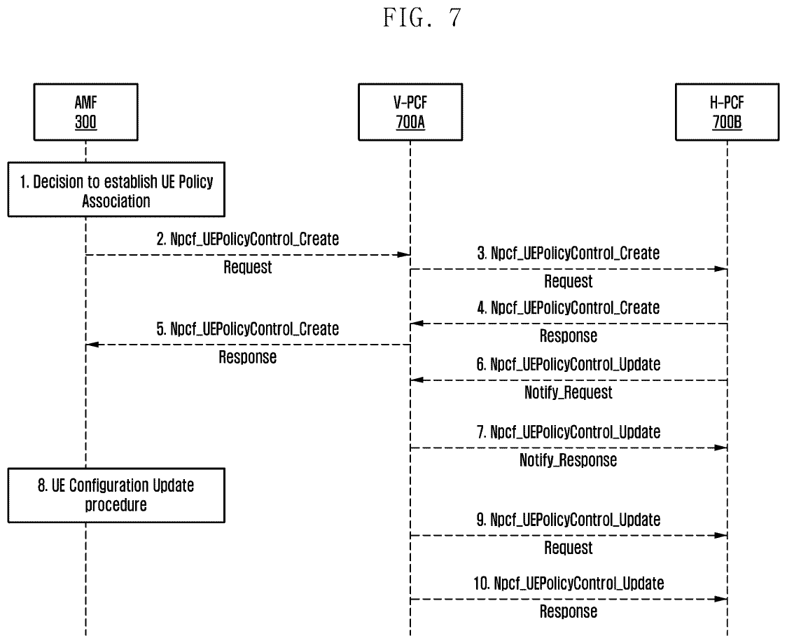

FIG. 7 illustrates a method, wherein the policy related to RAT Restriction Information can be delivered to the UE by the PCF, according to an embodiment.

Referring to FIG. 7 in step 1, the AMF (300) establishes the UE policy association with the visited policy control function (V-)PCF (700A) when a UE policy container is received from the UE (100). If a UE policy container is not received from the UE (100), the AMF (300) may establish UE policy association with the (V-)PCF 700A based on AMF local configuration.

In step 2, the AMF (300) sends an Npcf_UEPolicyControl Create Request to the V-PCF 700A.

In step 3, the V-PCF (700A) forwards the information received from AMF (300) in step 2 to the home PCF (H-PCF) (700B).

In step 4, the H-PCF (700B) sends a Npcf_UEPolicyControl Create Response or any signal to the V-PCF (700A) including the RAT Restriction Information.

In step 5, the (V-)PCF sends a Npcf_UEPolicyControl Create Response or any signaling including the RAT Restriction Information to the AMF (300). The (V-)PCF relays the Policy Control Request Trigger parameters in the Npcf_UEPolicyControl Create Response.

In step 6, the (H-)PCF gets policy subscription related information and the latest list of PSIs from the UDR using Nudr_DM_Query service operation (SUPI, Policy Data, UE context policy control data, Policy Set Entry) if either or both are not available and makes a policy decision.

In step 7, the V-PCF (700A) sends a response to H-PCF (700B) using Npcf_UEPolicyControl UpdateNotify Response.

In step 8, the (V-)PCF triggers a UE Configuration Update Procedure to send to the UE (100) policy container including UE policy information to the UE (100).

In step 9, if the V-PCF (700A) receives notification of the reception of the UE (100) Policy container, the V-PCF (700A) forwards the notification response of the UE (100) to the H-PCF (700B) using Npcf_UEPolicyControl_Update Request.

In step 10, the H-PCF (700B) sends a response to the V-PCF (700A). The AMF (300) delivers the RAT Restriction Information to the UE (100) in at least one of the NAS message.

In continuation of RAT restriction management, the policy applied to the UE (100) must be lifted under specific conditions, such as when a new policy no longer restricts the RAT, when the UE moves to a PLMN, TAI, Cell, or Area where the restriction is inapplicable, upon entering Emergency mode, Manual mode, or detecting a disaster condition, after the restriction duration specified by policy is completed, or when the UE (100) no longer supports the RAT restriction capability.

The RAT restriction policy must be lifted (i.e. a RAT can be enabled) on the following conditions:
a. The UE (100) receives a new policy that no longer restricts the RAT.
b. The UE (100) moves to a PLMN, TAI, Cell, Area for which the policy is inapplicable.
c. The UE (100) enters Emergency mode or Manual mode or detects a disaster condition.
d. The UE (100) has completed restricting the RAT for the time specified by policy.
e. The UE no longer supports RAT restriction capability.

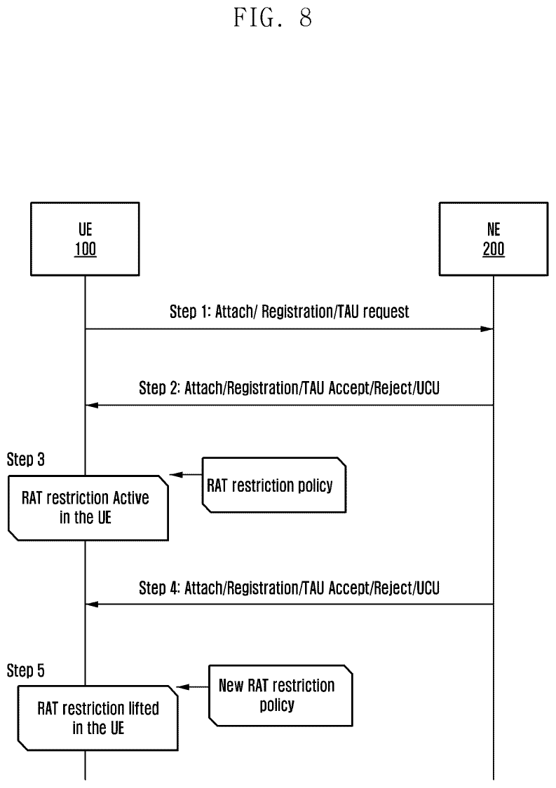

FIG. 8 illustrates a method for re-enabling a restricted RAT (lifting a RAT restriction) by policy update, according to an embodiment.

Referring to FIG. 8, a RAT is re-enabled at the UE (100) side through a policy update received from the network. Initially, the UE (100) initiates a NAS procedure such as Attach, Registration, or tracking area update (TAU) towards the network. In response, the network provides a RAT restriction policy, which the UE (100) uses to disable a specific RAT (e.g., EPS). Subsequently, the network sends an updated policy that lifts the earlier restriction. Based on the new policy, the UE (100) proceeds to re-enable the previously disabled RAT or PLMN, and effectively restoring access in accordance with the revised network configuration received in the policy (this can be also interpreted as deleting the old policy and storing the updated new policy received for the PLMN. Apply the new policy in the UE).

In FIG. 8, in step 1, the UE (100) initiates an attach/registration/TAU towards the network.

In step 2, the UE (100) receives a response from the network with a valid RAT restriction policy.

In step 3, the UE (100) disables the RAT (e.g. EPS) based on the RAT restriction policy.

In step 4, the UE (100) receives a new policy from the network which removes the RAT restriction that was previously applied at step 2.

In step 5, UE (100) re-enables the RAT/PLMN which it had disabled due to RAT restriction.

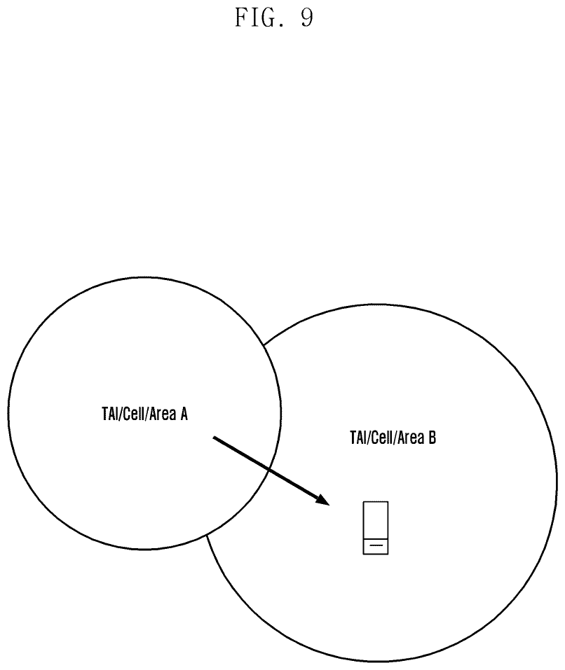

FIG. 9 illustrates a method wherein the RAT restriction is removed due to change of PLMN/TAI/Cell/Area, according to an embodiment.

Referring to FIG. 9, the UE is initially registered on TAI-1/Cell-1/Area A where a given RAT for e.g. LTE/E-UTRAN is disabled based on the RAT restrictions policy. The UE moves to new TAI-2/Cell-2/Area B where a given RAT e.g. LTE/E-UTRAN is allowed based on the RAT restrictions policy, then the UE will re-enable the restricted RAT.

As seen in FIG. 9, the UE is initially registered on TAI-1, Cell-1, within Area A (for example) where a specific RAT, for example LTE/E-UTRAN is disabled based on the RAT restriction policy broadcast or conveyed by the network. When the UE moves to a new location, for example TAI-2, cell-2, within Area B, the network policy applicable to the new area permits the previously restricted RAT. Moreover, upon detecting the new policy or network context, the UE determines that the RAT is no longer restricted and accordingly re-enables the previously disabled RAT (for example LTE/E-UTRAN), allowing (or enabling) this RAT to access or utilize services over the RAT in the new area. The adaptive behavior enables the UE to comply dynamically with location-specific network restrictions and capabilities.

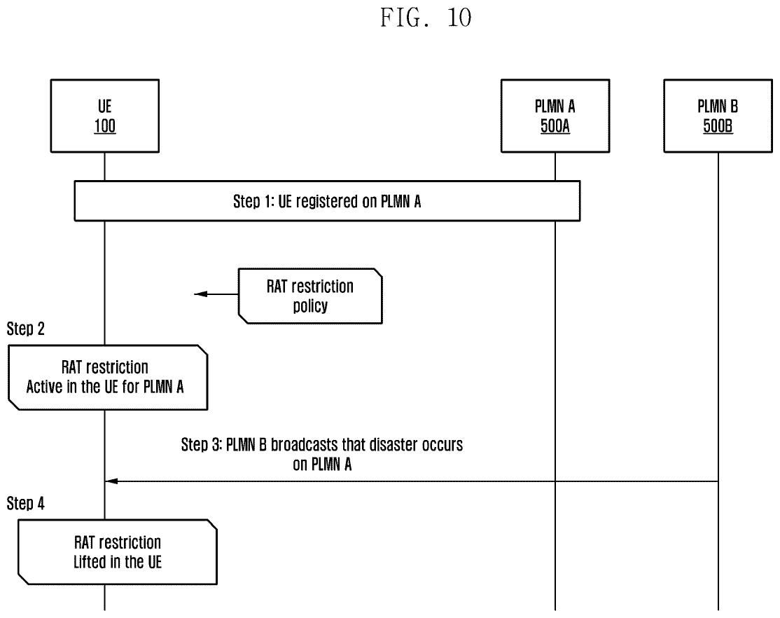

FIG. 10 illustrates a method wherein the RAT restriction is removed due to a disaster roaming condition, according to an embodiment.

Referring to FIG. 10, in step 1, the UE is initially registered on PLMN A (500A) and is camped on the NR (5G) RAT. A RAT restriction policy is active for the UE, which prohibits access to the LTE RAT based on network-determined conditions and policies received from the network (e.g., via the AMF (300), UDM (400), or PCF). The policy ensures the UE operates only on allowed RATs under normal conditions to maintain network efficiency and compliance.

In step 2, the UE continues operating under the active RAT restriction while in coverage of PLMN A (500A). The RAT restriction controller in the UE enforces this policy, disabling LTE access as per the configured restriction, even if LTE cells are available.

In step 3, the UE loses coverage of PLMN A (500A) and detects a PLMN B (500B), which broadcasts that a disaster has occurred on PLMN A (500A).

In step 4, the UE removes the previously applied RAT restriction and re-enables the LTE RAT. It is possible that the UE may now find a normal service on PLMN A (500A) in LTE.

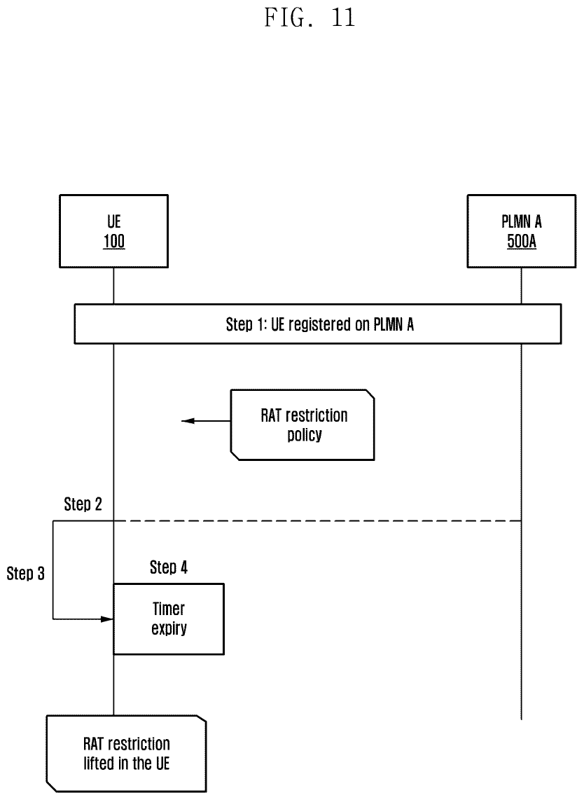

FIG. 11 illustrates a method, wherein the RAT restriction is removed due a due to timer expiry, according to an embodiment.

Referring to FIG. 11, the UE (100) is initially registered on PLMN A (500A) with an active RAT restriction. The UE (100) receives a timer value for which the RAT should be restricted, such as between 2 p.m to 4 p.m LTE should be disabled, 60 mins timer from 2 O'clock LTE should be disabled, or when the message is received, disable the LTE RAT for 1 or 2 hours. The UE (100) will disable the RAT for e.g. LTE when the start time of the RAT restriction occurs based on RAT restriction information. After the time for which the RAT restriction was supposed to be in effect as per the policy has elapsed, the UE (100) re-enables the restricted RAT.

In step 1, the UE (100) registers on PLMN A (500A) with an active RAT restriction policy, which includes a time-based condition for restricting access to a specific RAT, such as LTE.

In step 2, the UE (100) receives RAT restriction information from the network, which includes a timer or time window defining when the restriction should apply. This may include specific time intervals (e.g., from 2:00 p.m. to 4:00 p.m.), duration-based conditions (e.g., disable LTE for 60 minutes starting from 2:00 p.m.), or an absolute timer triggered upon receipt of the restriction message (e.g., disable LTE for 60 or 120 minutes after message reception).

In step 3, when the configured start time or triggering condition occurs, the UE (100) disables the corresponding RAT (e.g., LTE) as instructed by the received restriction policy. The RAT restriction controller in the UE (100) ensures compliance with the time-based rule.

In step 4, once the timer expires or the defined time window elapses, the RAT restriction period ends. The UE (100) automatically re-enables the previously restricted RAT (e.g., LTE), thereby restoring full RAT availability in accordance with the expired policy.

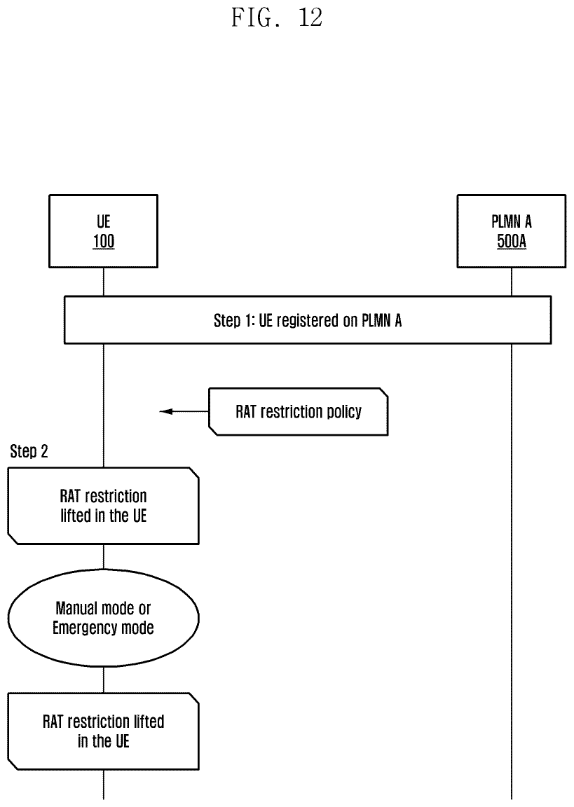

FIG. 12 illustrates a method, wherein the RAT restriction is removed due to manual or emergency mode, according to an embodiment.

Referring to FIG. 12, the UE (100) is registered on PLMN A (500A) with an active RAT restriction; i.e., a given RAT is disabled. The UE (100) enters Manual mode or Emergency mode to re-enable the disabled RAT.

If the UE (100) selects a PLMN for which the RAT restriction is inapplicable as per RAT restrictions policy, the UE (100) re-enables the RAT.

If the UE (100) selects a TAI for which there is no RAT restriction as per RAT restrictions policy, the UE (100) re-enables the RAT.

If the UE (100) selects a cell for which there is no RAT restriction as per RAT restrictions policy, the UE (100) re-enables the RAT.

If the UE (100) enters an area for which there is no RAT restriction as per RAT restrictions policy, the UE (100) re-enables the RAT.

If the current time is greater than the time duration for which RAT restriction was enforced as per RAT restrictions policy, the UE (100) re-enables the RAT.

If the UE (100) receives a new RAT restriction policy which does not restrict the RAT for the given PLMN, TAI, Cell or Area, the UE (100) shall re-enable the RAT.

If the UE (100) had applied RAT restriction and the UE setting has changed such that it does not support RAT restriction anymore, the RAT restriction should be disabled and the respective RATs should be enabled.

If the UE (100) was rejected with cause #15 or #27 earlier and the RAT restriction policy does not restrict that RAT, then, the RAT shall be re-enabled.

If the UE (100) enters Emergency mode, or detects a disaster condition or enters Manual mode, the UE (100) shall undo the RAT restrictions.

In step 1, the UE (100) registers on PLMN A (500A) with an active RAT restriction policy.

In step 2, the UE (100) receives RAT restriction information from the network, and the access to the RAT associated with the RAT restriction information is restricted based on the RAT restriction policy. The UE (100) can identify that the RAT restriction has been lifted due to a specific cause (e.g., the cause of FIG. 11 and FIG. 12). Or in case that the UE enters Emergency mode, detects a disaster condition, or enters manual mode, the UE (100) shall undo/lift/remove the RAT restrictions in the UE.

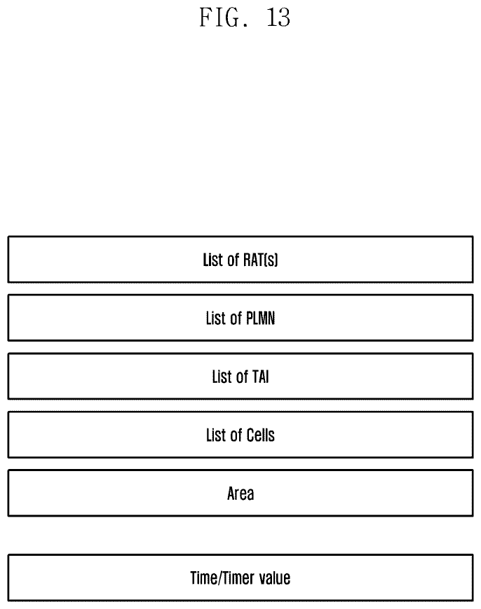

FIG. 13 illustrates the RAT restriction information/policy, according to an embodiment.

Referring to FIG. 13, the RAT restriction information/policy can be delivered to the UE such that at least one of the below in any order/combination is used to determine if a given RAT is allowed or forbidden to the UE.

Per PLMN-ID: RAT can be restricted on a per PLMN basis. E.g., PLMN-1: Allowed: RAT-1, 2, Forbidden RAT-3, 4.

Per TAI: RAT is restricted for a given TAI/RA or for a list of TAI/RA; for example, TAI-1: Allowed: RAT-1, 2, Forbidden RAT-3, 4.

Per cell: RAT can be restricted per PCI/ARFCN or per Global cell ID or for a list of cells; for example, Cell-ID-1: Allowed: RAT-1, 2, Forbidden RAT-3, 4.

Per area: Allowed area for a given RAT or forbidden Area for a given RAT.

Per time: Example: LTE RAT optionally on PLMN X is forbidden from 9 AM to 6 PM, or NR is forbidden on a list of TAIs for the next two hours, or the time may start when a message or indication is received from the network.

until the duration expires.

Per RAT type: This indicates the information.

On whether a given RAT is allowed or forbidden for the UE.

If the RAT restriction policy is received from the AMF, by means of signaling such as UCU, Attach/Registration/TAU accept or reject or Detach/Deregistration request, then, the policy is applied to that PLMN only.

If the RAT restriction policy is delivered by HSS/UDM (400) by procedures such as SOR/UPU, then the HPLMN can also update the policy for other PLMNs.

Before the policy is exchanged between the UE and network, the UE should have indicated the support for RAT restriction in the UE capability exchange.

Once the UE receives the RAT restriction policy, the existing policy, if any, will be replaced with the received policy.

The RAT restriction policy is inapplicable to a UE in Emergency mode or when a Disaster condition is Detected or when the UE is camped for Disaster roaming or when the UE is in Manual mode.

If the UE received a reject cause earlier (say #27) which restricted the UE on a particular RAT and the new policy does not restrict that RAT for the UE, the UE is allowed to access the RAT.

If the UE has restricted a RAT due to Voice not being available on that RAT, then, the RAT restriction policy does not take effect for that RAT.

If all of the supported RAT of the UE are restricted for a PLMN, it should be treated as an FPLMN.

The term area/location/geographical area are used in this embodiment may refer to any of cell/cell ID, TAC/TAI, PLMN, MCC/MNC, Latitude/longitude, CAG cell or any geographical location/coordinate.

If the network did not include a timer value for the RAT restriction, then the UE may choose a time duration ‘T’ for which the policy will be in effect. It is up to UE implementation on what duration to choose for ‘T’.

The UE indicates the capability (support of not support) of RAT restriction information feature to at least one of the AMF, UDM or the PCF for e.g., using UPSI, MM capability information in any of the NAS or AS message. If the UE indicates support of the feature only then the UDM/PCF/AMF indicates the RAT restriction information to the UE.

The UE indicates whether the UE supports/does not support RAT restriction feature in the 5GMM capability IE of the registration request message to the AMF. The AMF further indicates whether the UE supports/does not support the RAT restriction feature received in the 5GMM capability IE to the PCF and UDM/HSS.

The UE indicates whether the UE supports/does not support RAT restriction feature in the MS network capability or UE network capability IE in the attach request or TAU request message to the MME. The MME further indicates whether the UE supports/does not support the RAT restriction feature received in the respective IE to the PCF and the UDM/HSS.

The UE indicates whether the UE supports/does not support RAT restriction feature in the UE state indication or policy container in registration request to the PCF. The PCF updates the UDM/HSS with the received support indicating whether the UE supports/does not-support the RAT restriction feature in the UE state indication or policy container or any other IE which is sent to the PCF.

The UE indicates whether the UE supports/does not support RAT restriction feature protocol configuration option (PCO) to the SMF/PGW. The SMF/PGW sends whether the UE supports/does not support the RAT restriction feature from the PCO to the PCF and UDM/HSS.

The network function e.g., the AMF, UDM or PCF indicates to the UE whether RAT-2 (for e.g., LTE) is allowed (not restricted) or forbidden (restricted) when the UE is camped on the RAT-1 (for e.g., the 5GS). The UE can disable the LTE RAT when such a policy is delivered to the UE on the 5GS RAT.

Consider the UE has received the reject cause #15 or #27 or any other cause or due to the reasons specified in the relevant standard (e.g., TS 24.301 or TS 24.501) the UE disables a given RAT. The UE also starts a timer for e.g., Tx like TD, TF, TG, TH etc. during that duration the RAT is disabled by the UE. While the respective timers are running if the UE receives a policy i.e. RAT restriction information and it indicates that the RAT is allowed for the UE (based on the RAT restriction information) then UE can stop the corresponding timer for e.g. Tx like TD, TF, TG, TH etc. and re-enable the respective RAT.

Disabling a particular RAT implies that the UE either:
a) deactivate/disable the access stratum of a particular RAT; or
b) The UE will not deactivate the access stratum of a particular RAT, but it will not select/reselect to that RAT i.e. will not use this RAT but continues to scan frequencies/search cells of the respective RAT to see if any allowed area/TAI will be available for the UE based on RAT restriction information.

Disabling a particular RAT implies that the UE:
a) Can deactivate/disable the access stratum of a particular RAT; or
b) The UE will not deactivate the access stratum of a particular RAT, but it will not select/reselect (doesn't select/reselect a cell of the restricted RAT) to that RAT i.e. will not use this RAT but continues to scan frequencies/search cells of the respective RAT to see if any allowed area/TAI will be available for the UE based on RAT restriction information (i.e. if the cell/TAI/location area is available on unrestricted access, the UE select/reselect on the cell/TAI/location area. if the cell/TAI/location area is available on restricted access, the UE does not select/reselect on the cell/TAI/location area).

To prevent repeated attempts to obtain normal service on a restricted PLMN/access technology combination, the MS shall provide the list of “PLMNs with associated access technology restrictions” to lower layers to exclude the restricted access technologies for cell selection and cell reselection on this PLMN as in the relevant standard (e.g., 3GPP TS 38.304 or 3GPP TS 36.304). The UE will scan for restricted RAT but the UE will not select or reselect RAT which is restricted for the PLMN.

When the UE receives EMM cause #15 “no suitable cells in tracking area” and an Extended EMM cause IE with value “E-UTRAN not allowed” in Downlink NAS message (e.g., attach reject) in response to any Uplink NAS message (e.g., attach request), then the UE disable the E-UTRA capability for the PLMN (e.g., PLMN-1) on which the reject is received. The UE also memorizes the UE has disabled E-UTRA capability on PLMN (e.g., PLMN-1) due to EMM cause #15 “no suitable cells in tracking area” and an Extended EMM cause IE with value “E-UTRAN not allowed”. When the UE is provisioned with the RAT restriction policy and E-UTRAN is enabled for PLMN-1, the UE shall re-enable E-UTRA capability on the PLMN-1. Optionally, if the E-UTRA capability is disabled due to other reason (e.g., 5 attach reject or any NAS related procedure) then the UE will not re-enable the E-UTRA capability if the RAT restriction policy is provisioned with E-UTRA allowed for the PLMN-1.

When the UE receives 5GMM cause #27, (N1 mode not allowed), “Downlink NAS message (e.g., registration reject) in response to any Uplink NAS message (e.g., registration request), then the UE disable the N1 mode capability for the PLMN (e.g., PLMN-1) on which the reject is received. The UE also memorizes the UE has disabled N1 mode capability on PLMN (e.g., PLMN-1) due 5GMM cause #27, (N1 mode not allowed). When the UE is provisioned with the RAT restriction policy and N1 mode is enabled, the UE shall re-enable N1 mode capability on the PLMN-1. Optionally, if the N1 mode capability is disabled due to other reason (e.g., 5 reject or any NAS related procedure) then the UE will not re-enable the N1 mode capability if the RAT restriction policy is provisioned with E-UTRA allowed for the PLMN-1.

If the UE in NB-S1 mode receives an ATTACH REJECT or TRACKING AREA UPDATE REJECT message including both EMM cause #15 “no suitable cells in tracking area” and an Extended EMM cause IE with value “NB-IoT not allowed” after the UE requests access to the NB-IoT, the UE may disable the NB-IoT capability, and indicate the access stratum layer(s) of disabling of the NB-IoT capability.

In this case, the UE memorizes the identity of the PLMN where the NB-IoT capability was disabled (e.g., UE on PLMN-1 received the reject). When the UE receives the RAT restriction policy with NB-IOT allowed for PLMN-1, then the UE shall enable the NB-IOT capability for the PLMN-1. NAS also indicate NB-IOT support on PLMN-1 to the AS layer

When the UE has the existing RAT restriction policy indicating that RAT-x on PLMN-1 is allowed, the UE may access to the RAT-x for the PLMN. When the UE receives new RAT restriction policy with the RAT-x is not allowed for the PLMN-1, the UE shall disable the RAT-x for the PLMN.

When the UE has the persistent PDU session or emergency PDU session on the PLMN and the UE receives policy which causes enable or disable the N1 mode capability or E-UTRA capability (or UTRA/GERAN capability), the UE may enable or disable enable or disable the N1 mode capability or E-UTRA capability (or UTRA/GERAN capability) when persistent PDU session is ended or emergency PDU session is ended or emergency PDN connection is ended or persistent EPS bearer is released.

If the UE has a RAT restriction policy indicating that RAT-x is not allowed on PLMN-1 and later receives a RAT restriction policy indicating that RAT-x is allowed on the RAT-x on PLMN-1, the UE shall enable RAT-x on PLMN.

When the specific RAT is not allowed for the PLMN (e.g., PLMN-1, RAT-X is not allowed), the NAS shall remove the corresponding RAT support indicated to the AS (access stratum). In this case, AS layer will not indicate the corresponding RAT capability in the RRC capability information message to the RAN (eNB, gNB, RAN, etc.) in response to the UE capability information.

If the UE has RAT restriction policy with RAT-x is allowed on PLMN-1 and later received RAT restriction policy indicating that RAT-x is not allowed on the RAT-x on PLMN-1, the UE shall disable RAT-x on PLMN.

In an embodiment herein, RAT or RAT-x can be E-UTRAN (S1 mode), NG-RAN (N1 mode) satellite NG-RAN, NB-IoT, GERAN, UTRAN, 1×RTT, and so on.

The network, UDM/HSS can configure RAT restriction policy for the access e.g., PLMN-1 is allowed on 3GPP access or PLMN-1 not allowed for non-3GPP etc. if the UE receive the RAT restriction including access restriction for the PLMN (e.g., PLMN-1 is allowed/not allowed for 3GPP), the UE shall not search and register on the on the access on the PLMN (e.g., PLMN-1) which is not allowed (e.g. PLMN-1 is not allowed on 3GPP access then the UE shall not search and register on 3GPP access. 3GPP access shall be disabled for 3GPP access for PLMN-1 and the UE shall not allow any HO (handover) from non-3GPP (or ePDG/EPC) to 3GPP on PLMN-1).

AT and the Radio access technology (RAT) is interchangeably used.

The policy generally refers to the RAT restriction information sent in the Access technology utilization control IE in the NAS message.

Embodiments herein may be described and illustrated in terms of blocks which perform a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The embodiments disclosed herein can be implemented through at least one software program running on at least one hardware device and performing network management functions to control the network elements. The elements include blocks which can be at least one of a hardware device, or a combination of hardware device and software module.

The embodiments disclosed herein describe methods and systems for managing RAT restrictions for ECRATU. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., very high speed integrated circuit hardware description language (VHDL) another programming language, or implemented by one or more VHDL or several software modules being executed on at least one hardware device. The hardware device can be any type of portable device that can be programmed. The device may also include means which could be e.g., hardware means like e.g., an ASIC, or a combination of hardware and software means, e.g. an ASIC and an FPGA, or at least one microprocessor and at least one memory with software modules located therein. The method embodiments described herein could be implemented partly in hardware and partly in software. Alternatively, the invention may be implemented on different hardware devices, e.g., using a plurality of CPUs.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method performed by a terminal in a communication system, the method comprising:
transmitting, to a network function related to mobility management, a first non-access stratum (NAS) message including capability information that indicates whether the terminal supports an access technology utilization control;
receiving, from the network function, a second NAS message including information on the access technology utilization control, the information on the access technology utilization control indicating restricted access technology associated with a current public land mobile network (PLMN);
storing the information on the access technology utilization control; and
applying the information on the access technology utilization control for a cell selection and a cell reselection in the current PLMN to restrict access to the restricted access technology.

2. The method of claim 1,
wherein information on an identifier (ID) associated with the current PLMN is stored with the information on the access technology utilization control, and
wherein, in case that the terminal is in a manual mode or an emergency mode, the terminal is allowed to access the restricted access technology.

3. The method of claim 1, further comprising:
receiving, from the network function, information on an updated access technology utilization control; and
replacing the stored information on the access technology utilization control to the information on the updated access technology utilization control.

4. The method of claim 1,
wherein in case that the network function is an access and mobility management function (AMF), the first NAS message is a registration request message and the second message is a registration accept message, a registration reject message, a service reject message, a de-registration request message, or a user equipment (UE) configuration update message, and
wherein in case that the network function is a mobility management entity (MME), the first NAS message is an attach request message or a tracking area update request message, and the second NAS message is an attach accept message, an attach reject message, a service reject message, a detach request message, a tracking area update accept message, a tracking area update reject message or a globally unique temporary identifier (GUTI) reallocation command message.

5. A method performed by a network function related to mobility management in a communication system, the method comprising:
receiving, from a terminal, a first non-access stratum (NAS) message including capability information that indicates whether the terminal supports an access technology utilization control; and
transmitting, to the terminal, a second NAS message including information on the access technology utilization control, the information on the access technology utilization control indicating restricted access technology associated with a current public land mobile network (PLMN),
wherein the information on the access technology utilization control is applied for a cell selection and a cell reselection in the current PLMN for restricting access of the terminal to the restricted access technology.

6. The method of claim 5,
wherein information on an identifier (ID) associated with the current PLMN transmitted with the information on the access technology utilization control, and
wherein, in case that the terminal is in a manual mode or an emergency mode, the access of the terminal to the restricted access technology is allowed.

7. The method of claim 5, further comprising:
transmitting, to the terminal, information on an updated access technology utilization control,
wherein the information on the access technology utilization control is replaced to the information on the updated access technology utilization control in the terminal.

8. The method of claim 5,
wherein in case that the network function is an access and mobility management function (AMF), the first NAS message is a registration request message and the second message is a registration accept message, a registration reject message, a service reject message, a de-registration request message, or a user equipment (UE) configuration update message, and
wherein in case that the network function is a mobility management entity (MME), the first NAS message is an attach request message or a tracking area update request message, and the second NAS message is an attach accept message, an attach reject message, a service reject message, a detach request message, a tracking area update accept message, a tracking area update reject message or a globally unique temporary identifier (GUTI) reallocation command message.

9. A terminal in a communication system, the terminal comprising:
a transceiver;
a processor communicatively coupled to the transceiver; and
memory, communicatively coupled to the processor, storing instructions executable by the processor to cause the terminal to:
transmit, to a network function related to mobility management, a first non-access stratum (NAS) message including capability information that indicates whether the terminal supports an access technology utilization control,
receive, from the network function managing mobility, a second NAS message including information on the access technology utilization control, the information on the access technology utilization control indicating restricted access technology associated with a current public land mobile network (PLMN),
store the information on the access technology utilization control, and
apply the information on the access technology utilization control for a cell selection and a cell reselection in the current PLMN to restrict access to the restricted access technology.

10. The terminal of claim 9,
wherein information on an identifier (ID) associated with the current PLMN is stored with the information on the access technology utilization control, and
wherein, in case that the terminal is in a manual mode or an emergency mode, the terminal is allowed to access the restricted access technology.

11. The terminal of claim 9,
wherein the instructions executable by the processor further cause the terminal to:
receive, from the network function, information on an updated access technology utilization control, and
replace the stored information on the access technology utilization control to the information on the updated access technology utilization control.

12. The terminal of claim 9,
wherein in case that the network function is an access and mobility management function (AMF), the first NAS message is a registration request message and the second message is a registration accept message, a registration reject message, a service reject message, a de-registration request message, or a user equipment (UE) configuration update message, and
wherein in case that the network function is a mobility management entity (MME), the first NAS message is an attach request message or a tracking area update request message, and the second NAS message is an attach accept message, an attach reject message, a service reject message, a detach request message, a tracking area update accept message, a tracking area update reject message or a globally unique temporary identifier (GUTI) reallocation command message.

13. A network function related to mobility management in a communication system, the network function comprising:
a transceiver;
a processor communicatively coupled to the transceiver; and
memory, communicatively coupled to the processor, storing instructions executable by the processor to cause the network function to:
receive, from a terminal, a first non-access stratum (NAS) message including capability information that indicates whether the terminal supports an access technology utilization control, and
transmit, to the terminal, a second NAS message including information on the access technology utilization control, the information on the access technology utilization control indicating restricted access technology associated with a current public land mobile network (PLMN),
wherein the information on the access technology utilization control is applied for a cell selection and a cell reselection in the current PLMN to restrict access of the terminal to the restricted access technology.

14. The network function of claim 13,
wherein information on an identifier (ID) associated with the current PLMN transmitted with the information on the access technology utilization control, and
wherein, in case that the terminal is in a manual mode or an emergency mode, the access of the terminal to the restricted access technology is allowed.

15. The network function of claim 13,
wherein the instructions executable by the processor further cause the network function to transmit, to the terminal, information on an updated access technology utilization control, and
wherein the information on the access technology utilization control is replaced to the information on the updated access technology utilization control in the terminal.

16. The network function of claim 13,
wherein in case that the network function is an access and mobility management function (AMF), the first NAS message is a registration request message and the second message is a registration accept message, a registration reject message, a service reject message, a de-registration request message, or a user equipment (UE) configuration update message, and
wherein in case that the network function is a mobility management entity (MME), the first NAS message is an attach request message or a tracking area update request message, and the second NAS message is an attach accept message, an attach reject message, a service reject message, a detach request message, a tracking area update accept message, a tracking area update reject message or a globally unique temporary identifier (GUTI) reallocation command message.
